(19) United States
(12) Patent Application Publication
(10) Pub. No.: US 2015/0220984 A1
(43) Pub. Date: Aug. 6, 2015

(54) CUSTOMER ENGAGEMENT ACCELERATOR

(71) Applicant: Microsoft Corporation, Redmond, WA (US)

(72) Inventors: Matthew Woodget, Bellevue, WA (US); Kelly Rigotti, Kirkland, WA (US); Fred Studer, Redmond, WA (US)

(73) Assignee: Microsoft Corporation, Redmond, WA (US)

(21) Appl. No.: 14/174,626

(22) Filed: Feb. 6, 2014

(51) Int. Cl. G06Q 30/02

(52) U.S. Cl. CPC G06Q 30/0255; G06Q 30/0201

(57) ABSTRACT

Technologies are generally provided for an iterative and analytical service that draws on a customer's footprint, a company's institutional knowledge, and interactions between the two to augment these roles' capabilities for delivering enhanced customer experiences. An example service may facilitate the interactions between a company and its customers, by enabling customer facing roles to be faster, better, smarter, so that the customer feels served, supported, and powerful and that companies are more agile in how they deliver marketing, selling and customer service. Intelligent, scalable, and timely recommendations based on learned customer interaction and activity may be provided, while allowing any given person in an external facing role the autonomy of action. The company and customer actions may feed back into and iterate the model.

### BACKGROUND

The moment of customer engagement is a make or break opportunity, be it for sales, marketing or customer service roles. The lines between sales, marketing, and customer support teams are increasingly blurring. In many environments, customer and prospect engagement now happens in an ever increasing set of places. For example, 50-70% of a customer's decision making may have already happened before they first enter into a company's sales process. Customers frequently expect a personalized, responsive, and effective experience and a high level of engagement from the company.

At the same time, customers leave an increasingly large digital and social footprint as they go about their business and personal activities online. Existing tools do not equip sellers, marketers, or customer service agents to rapidly infer meaningful insights they may glean from customer behavior while also recommending meaningful actions or responses that ensure an optimal moment of engagement. Tactics for any given engagement for sales, marketing and customer service are increasingly large and fragmented and thus involve a great amount of institutional awareness and role skills/experience.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to an iterative and analytical service that draws on a customer's footprint, a company's institutional knowledge, and interactions between the two to augment these roles' capabilities for delivering enhanced customer experiences. An example service according to some embodiments may facilitate the interactions between a company and its customers, by enabling customer facing roles to be faster, smarter, so that the customer feels served, supported, and powerful and that companies are more agile in how they deliver marketing, selling and customer service. Intelligent, scalable, and timely recommendations based on learned customer interaction and activity may be provided, while allowing any given person in an external facing role the autonomy of action. The company and customer actions may feed back into and iterate the model.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 illustrates an example environment, where customer interactions may be enhanced through a customer engagement accelerator according to some embodiments;

FIG. 2 illustrates main functional blocks in an example customer engagement accelerator according to embodiments;

FIG. 3 through FIG. 5 illustrate an example iterative and integrated process and phases of a customer engagement acceleration process according to some embodiments;

FIG. 6 is a networked environment, where a system according to embodiments may be implemented;

FIG. 7 is a block diagram of an example computing operating environment, where embodiments may be implemented; and

FIG. 8 illustrates a logic flow diagram for a process of accelerating customer engagement according to embodiments.

### DETAILED DESCRIPTION

As briefly described above, intelligent, scalable, and timely recommendations based on learned customer interaction and activity may be provided by a customer engagement accelerator, while allowing any given person in an external facing role the autonomy of action. Company and customer actions may feed back into and iterate the integrated and iterative engagement acceleration model.

In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable storage medium can for example be implemented via one or more of a volatile computer memory, a non-volatile memory, a hard drive, a flash drive, a floppy disk, or a compact disk, and comparable hardware media.

Throughout this specification, the term “platform” may be a combination of software and hardware components for facilitating customer engagement. Examples of platforms include, but are not limited to, a hosted service executed over a plurality of servers, an application executed on a single computing device, and comparable systems. The term “server” generally refers to a computing device executing one or more software programs typically in a networked environment. A server may also be implemented as a virtual server (software programs) executed on one or more computing devices viewed as a server on the network. More detail on these technologies and example operations is provided below.

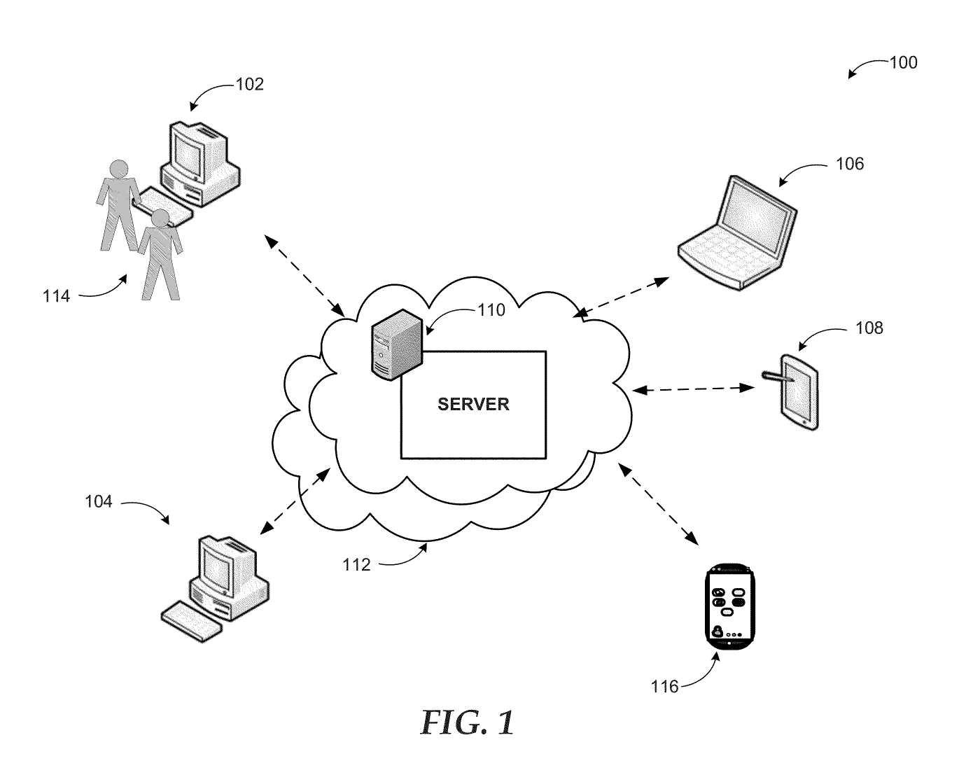

Referring to FIG. 1, diagram 100 illustrates an example environment, where customer interactions may be enhanced through a customer engagement accelerator according to some embodiments. The computing devices and computing environments shown in diagram 100 are for illustration purposes. Embodiments may be implemented in various local, networked, and similar computing environments employing a variety of computing devices and systems.

Diagram 100 represents networked computing environment, where a customer engagement service such as a customer resource management (CRM) service may facilitate activities associated with servicing existing customers, engaging new customers, etc. As such, the service, executed on one or more servers represented by server 110 may enable various professionals 114 in sales, marketing, and customer service roles to access the resources managed by the service through a variety of client devices 102, 104 over one or more networks 112. The service may interact with or monitor interactions of a variety of customers and potential customers through their respective client devices 106, 108, and 116.

To facilitate customer engagement, an example service may include a marketing application that determines/provides recommended tactics that are proposed/served up to sales/marketing/customer service. The service may employ a social technology that enables teams to leave feedback and interact with others. A sentiment monitoring and measuring application may be used along with a supply chain application to provide insight to inform inventory needed to create products. A distribution management application may provide insight to help with planning product shipments. On retail side, input may be provided into omni-channel marketing plans, which may benefit from insight inferred from the customer engagement accelerator. A service industry module may enable the service to benefit from insight of global/regional customer demands to allow better planning of resources.

The example systems in FIG. 1 have been described with specific servers, client devices, applications, and interactions. Embodiments are not limited to systems according to these example configurations. A platform providing customer engagement accelerator may be implemented in configurations employing fewer or additional components and performing other tasks. Furthermore, specific protocols and/or interfaces may be implemented in a similar manner using the principles described herein.

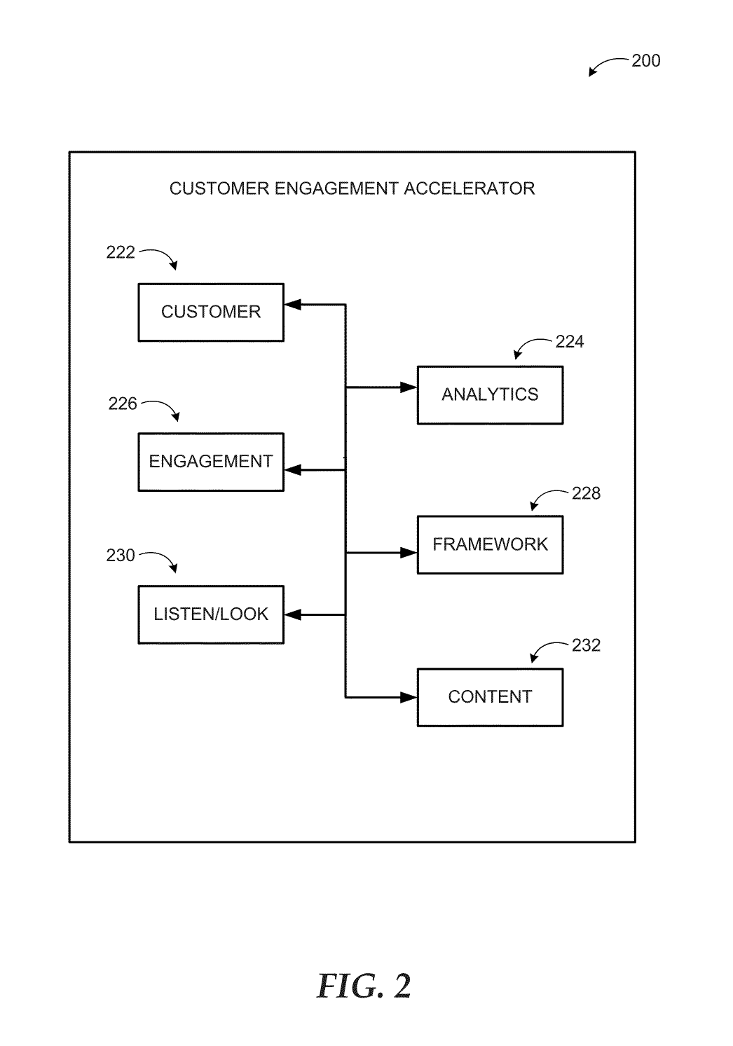

Referring to FIG. 2, diagram 200 illustrates main functional blocks in an example customer engagement accelerator according to embodiments.

Customer 222 may provide interactions, content consumption, and similar inputs to the system allowing the system to identify prospects, determine suitable content, and determine recommended actions. Analytics 224 may identify potential prospect profiles, refine context/actions, and perform analysis, trending, and inference processes. Engagement 226 may provide decisions on actions, determine recommended actions sets, and provide input to a refinement pool at the analytics 224 for selection of desired actions.

Framework 228 may host a universe of prospects and analysis on potential actions by the prospects, for example. A listen/look component 230 may enable the system to observe customer behavior through social/professional networks and other interaction environments to provide feedback/input to the universe of prospects analysis of desired actions, and refinement pool. Content 232 may host content to be provided to customers. The content may be created, syndicated, or purchased from other sources.

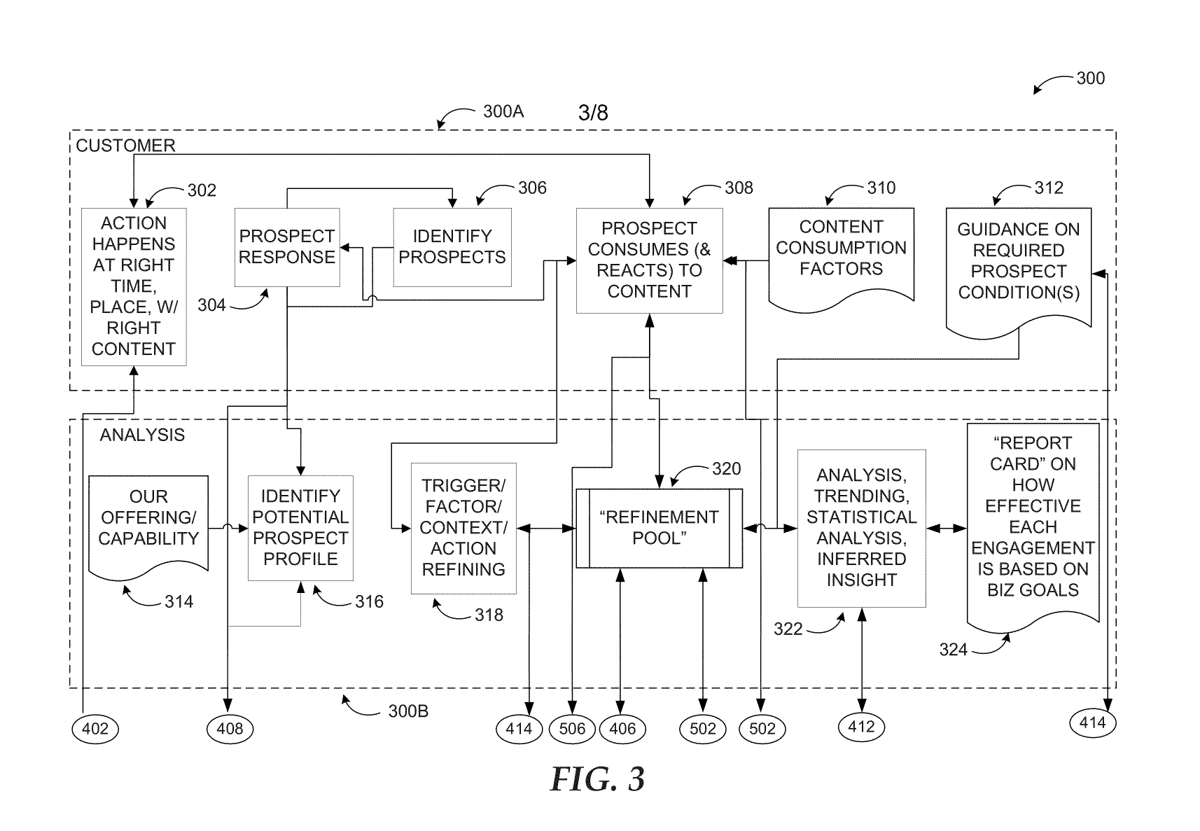

FIG. 3 through FIG. 5 illustrate an example iterative and integrated process and phases of a customer engagement acceleration process according to some embodiments.

Diagram 300 of FIG. 3 shows customer 300A and analysis 300B phases with major components, input elements, and processes. The interactions among the major components, input elements, and processes shown in FIG. 3 through FIG. 5 are for illustration purposes and do not constitute a limitation on embodiments. Neither are the specific components, input elements, and processes shown in FIG. 3 through FIG. 5 intended to be limiting on the embodiments. Embodiments may be implemented with additional or fewer components or processes, and with different interactions.

Customer 300A phase may include “Action happens at right time, place, with right content” 302. Prospect responses 304 and identification of prospects 306 may also be associated with the customer 300A phase. How a prospect consumes and reacts to content 308 and content consumption factors 310 may also be associated with the customer 300A phase along with guidance on prospect conditions 312.

Analysis 300B phase may include offering capabilities 314, identification of potential prospect profiles 316, and trigger/factor/context/action refining 318. Analysis, trending, statistical analysis, inferred insight 322 and report card on how effective each engagement is based on business goals 324 may also be part of analysis 300B phase. A key part of analysis 300B phase may include refinement pool 320 interacting with many other components as shown in the diagram.

Refinement pool 320 may refine actions based on output of the questions below, which may result in a positive, negative, or neutral value for either “predicted outcome of sales engagement”, “likelihood of responding to marketing messaging” and “predicted outcome of customer service engagement”, where negative=0, neutral=1, positive=2.

These three factors together may result in a code, e.g. Customer Service=0, Sales=1, Marketing=2. Suggested content for either pivot (Sales, Marketing or Customer Service) may be tagged as ‘recommended for X’ mix. The system may then recommend that content and allow pivot by each, some or all three areas.

Example (of multiple possibilities):

| | Trigger/Context | | | |
|---|---|---|---|---|
| Action | Factor | Sales | Marketing | Service |
| A | X | 1 | 1 | 1 |
| B | Y | 2 | 1 | 0 |
| C | Z | 0 | 0 | 2 |

In one example scenario, A may be recommended action for existing customer who is showing interest in upsell opportunities. In another example scenario, B may be recommended action for a strong sales opportunity that would benefit from marketing. In a further example scenario, C may be recommended action for an existing customer who may need to be focused on for providing service to.

The system may then receive input (automated or manual) as negative, neutral, or positive customer response to content/action/engagement, which may then be used as a multiplier for efficacy. For example: “Customer 1 was provided with Action A and responded positively.” This feedback may then update ‘efficacy’ (a weighted field) for the content, demonstrating the effectiveness of the content over time. If “Action A” ceases to be effective for customers, A may start to receive “0” as a multiplier and thus may be ‘de-ranked’ and less likely to be suggested in the future. Due to the customer profile angle, large data analysis may be important because of the potentially vast universe of prospects so that the efficacy of content is not subjected to human opinion alone, but trends are also recognized.

Human intervention may be a part of the equation at two key points: (1) During engagement/execution, an explicit “thumbs up/down” (or neutral) response may be received to suggested actions, and the decision may be made to move forwards with any given action by humans. (2) Systemic input may be received to review existing set of triggers/factors/context (TFC) and their associated actions, for adding new potential TFC and/or Actions, and/or for ranking “thumbs up/thumbs down” on combinations. These human interventions may be effectively a factor of the overall equation and a part of the iterative model.

The content in the system may be owned (created), purchased or shared (3^{rd} party). Over time, this may create a massive dataset that big data analysis can use to increase future suggestions on content/content sources (in case of purchased or 3^{rd} party).

Following questions may be used by the system for determining prospects, profiles, and markets:

Product/Service
Do they own/use offered product/service
Are they a customer who has bought offered products/services in the past
   i. One off
   ii. Frequent
Over time/Loyalty;
   i. Frequency of offered product/service use
   ii. If multiple products/services are offered, how many do they use
Do their friends or network use offered product/service
Have they historically used offered product/service (yes/no) and have ceased
   i. Relates to Over time/loyalty
   ii. Ceased recently, some time ago, long time agow?
      Using competitors product yes/no

Network & Communications
Who (what roles, which people) do they work with?
How do they communicate in general +/−/neutral
How do they communicate about offered product +/−/neutral
How do they communicate about industry/type of product or service +/−/neutral
In general they share a lot/somewhat/not much
   i. Same goes for ‘post’
On the topic of offered product/service (or similar) they share allot/somewhat/not much
   i. Same goes for ‘post’

Segmentation
How much do they match target profile?

What can the system learn (used to help refine and/or suggest content)?
Demographic values
Psychographic values
Professional verticals (e.g. industry)
Complimentary verticals

Are there qualifiers/disqualifiers?
Customer already bought offered products/services recently
Customer demonstrate ably positive/negative towards offered products/services/company

Content consumption factors
Yes/no
% consumed
Shared (# networks)
Contacts
interactions

Triggers, Factors, Context (TFC) & associated actions are items in the environment or behaviors or actions happening currently that may need to be considered when taking an action. These items may be refined over time based on the efficacy of actions upon those triggers/factors. For example, the system may discover talking about weather with prospects in Seattle is always associated with a positive deal outcome, or it might always be the opposite or it might not have any apparent relationship.

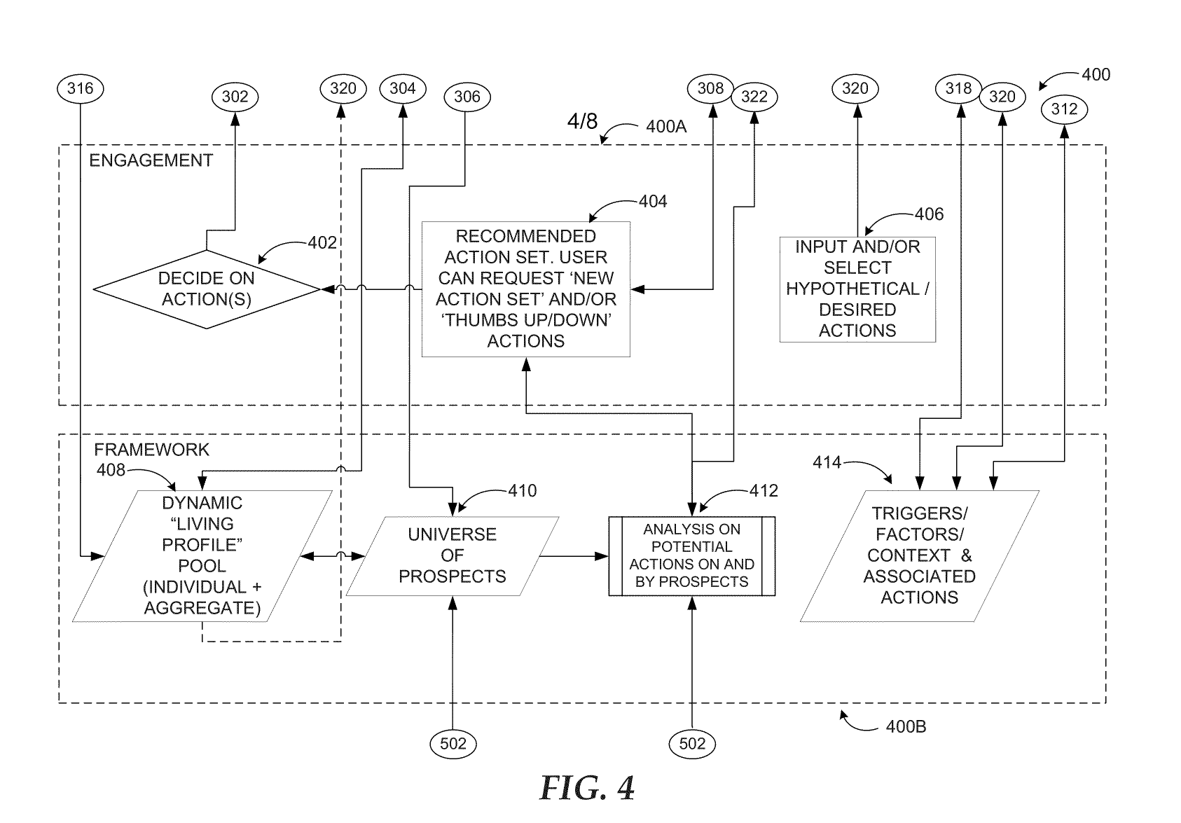

Diagram 400 of FIG. 4 includes two additional major phases of a customer engagement accelerator system: engagement 400A phase and framework 400B phase. Engagement 400A phase may include a decision on actions 402, a recommended actions set 404, and input and/or selection of hypothetical/desired actions 406. Framework 400B phase may include a dynamic profile pool (individual or aggregated) 408, a universe of prospects 410, and triggers/factors/context/associated actions 414. An analysis on potential actions on and by prospects 412 may be performed by the framework 400B phase.

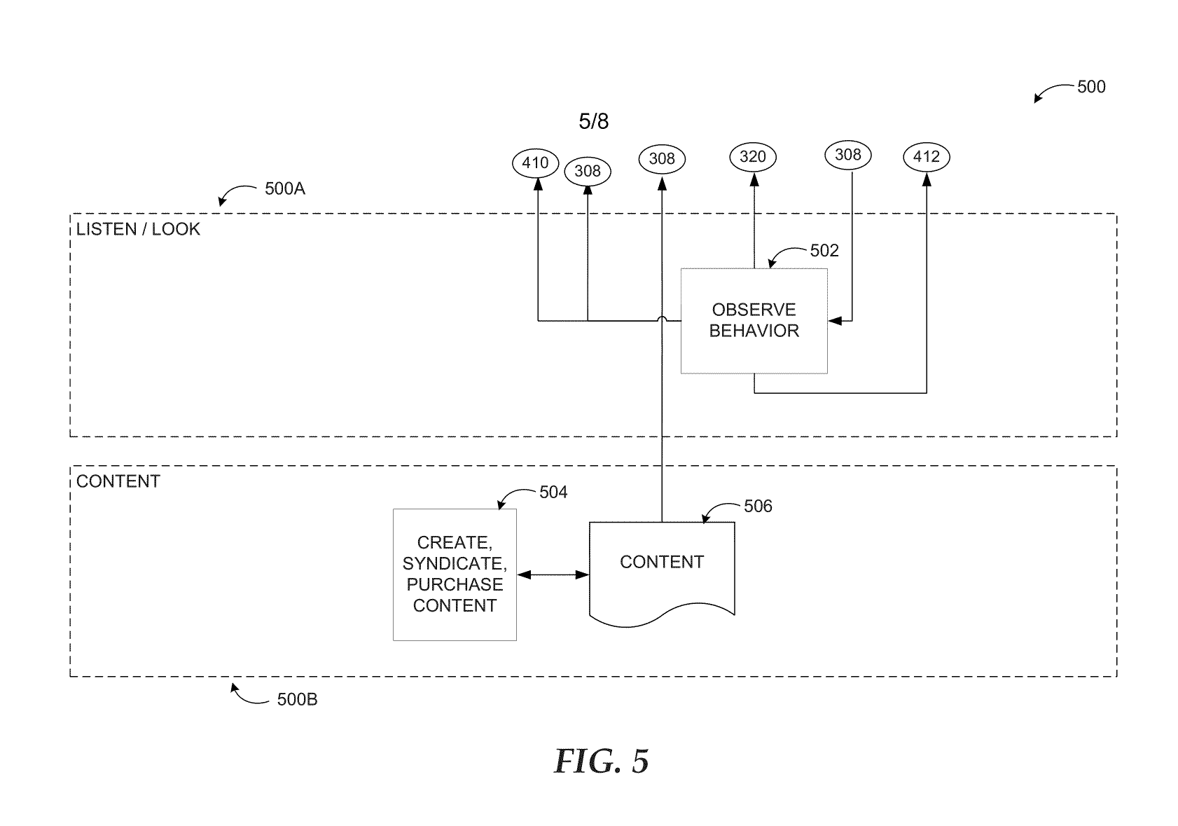

Diagram 500 of FIG. 5 includes two more major parts of the customer engagement accelerator system: listen/look 500A phase and content 500B phase. Listen/look 500A phase may include an observation module 502 for observing prospect behavior in associated with provided content, in response to actions, prior to actions, in other environments (e.g., social/professional networks), and under other circumstances. Content 500B phase may include content 506 that may be presented to prospects to affect their behavior. The content may be created, syndicated, or purchased (504).

“Factors” and “Actions” may vary from one company to another. There may be a default set of factors that may be edited and customized such as weather, location, sports, family events, company events, trending topics, and comparable ones. Factors may be set as ‘ongoing’ or ‘time bound’. For example, weather may be time bound to a week, an earthquake may be an important topic around engagement for multiple weeks, a political campaign/issue may be ongoing for months. Context may encompass things for a prospect, which can inform conversations (e.g., weather, sports) and ensure relevance and sensitivity to the customer's particular situation.

Triggers are the things the customer does, or happen related to the customer that may have a proactive response to. Things people do that indicate a type of engagement may be needed. For example, engagement may be a good idea or a bad idea at the current time, a person may clearly need customer service, or a customer may just have done something that is a strong indicator of needing a product.

Associated actions may be any potential marketing, sales or customer service action. In the manifestation of a system, associated actions may include pre-populated best practices. They may also be customized. There may be a large potential set of actions covering many of the best practices for sales, marketing, and/or customer support. The actions like the triggers, factors and context may be customizable.

Some example actions may include sending an email, making a phone call, asking generic/specific questions (examples of targeted actions); or aggregating actions such as suggesting a campaign for a set of prospects or purchasing advertising.

An interactive content planning service that enables marketers to deliver the right content marketing at the right time may be employed, where insight from social fuels planning may help determine what content to create and when to publish, and creation and delivery of content may be implicitly and explicitly aligned to business objectives and integrated into all up marketing planning. For example, an app based virtual video magazine with a mix of fictional and documentary style content that is intuitively navigated may be provided in a modern UI. The content may be highly shareable. Auto sharing may be enabled by opt-in and marketed within the app as ‘connect with likeminded people to help you be successful’, for example. When enabled the consumption and/or the liking/ranking/commenting on content may automatically share to the registered social networks.

In some example embodiments, the flow of the content may be designed to move prospects through six phases sequentially, where they move from potential to actual customer in a “Choose Your Own Adventure” approach with decisions on what content to consume facilitating movement through the experience via ‘Threads’.

The choices for “Choose Your Own Adventure” may be fueled by these attributes: (1) Implicit elements based on what the consumer says their attributes are (role type); (2) Explicit elements of what is being tried to achieve (e.g., “Today I'm planning for a customer presentation/going to visit a customer/researching my competition”); and (3) Explicit elements based on choices provided such as “Watch THIS or THAT”. The attributes/choices may move the consumer down predetermined paths of content. This may be characterized by them ‘discovering’ their own journey but may also be a low effort and easy to consume the content.

There may be 3, 5, 10, 50+ potential ‘threads’ or ‘adventures’, for example. Although for any specific campaign the number may be <10 due to focused value propositions and target sub segment audiences, for any given one, it may start with REALIZE and then move through each of the other phases discussed below. Content may be reusable across different threads, however. The six example phases may include:

REALIZE—Help prospect to realize a problem/challenge/opportunity they have. Problems may be determined or selected based on the value proposition that can be solved for by the customer engagement service. The realization may be served up with educational/entertainment/informative content. For example, what has changed in the world of a sales person in the past three years and what does that mean.

INTERNALIZE—Prospect may consume content that is relevant to their position/business/company. Content may be compelling, interesting, and entertaining, so that they remember and want to share the content. This level may be about internalizing the problem/challenge/opportunity thread the prospect is on. The system may help the prospects understand how their world could be different.

VISUALIZE—This may be content that helps the prospect see how to solve their problem or help form a solution to their problem. The prospects may be presented with one or more services/devices that can be used as a part of their solution to what they have realized and internalized. It may be pivoted around their needs for such situations. Navigation may happen in such a way that is natural and simple.

DECIDE—This may become an offer of engaging with a service provider. Content at this level may move from a preponderance of emotional content to that of detail. Content at this level may help the prospects understand how to apply this to their business and show evidence (real/document) of other customers like them doing the same.

JUSTIFY—Content at this level may present the “nitty-gritty” of how things get done within the provided service/device and broader service provider experience. While the presented product may not be explained in detail, it may be shown as specific business problems/challenges/market conditions are tackled utilizing the offered service.

EVANGELIZE—Content that helps the prospect share with others the ‘why’ of this experience may be presented at this phase. There may be the potential to enable user-generated content that allows existing customers (who are also potentially prospects in this experience) to then share their own stories.

Thus, a top-to-bottoms approach may be used both for content (from awareness to purchase) and for execution (field, partners, customer), where the combination of both may produce a sequential effect of content stepping stones/milestones that ready the field/partners and lead a customer to be more interested in buying through the experience and subsequent exposure to content than they would otherwise. The design of the system may ‘make it real’ for prospects above and beyond traditional advertising campaigns' “one size fits all” message and move to one that is customized to the need of the prospect by surfacing the right content and the right time, and iteratively create a reason to take the next step in the journey.

Sharing and social networking aspects may be designed to maximize the service provider's reach and impact with limited marketing funds. Content may be created that has value in its own right that is of value and thus has value to be shared. Content may be sharable at any point, easily, and across a user's social networks. A content architecture model may be generated for all aspects of a device/service launch including proportional mix of ‘emotional’ and ‘detail’ content editorialized and sequenced over time designed to move prospects through digital discovery and enable ‘prospects as evangelists’ in prospective customer companies. For example, gamification may be used to drive spread of content and message, where consumers of the content qualify for badges and points for consuming and sharing content. Flexible point model may be used to enable marketing to reward those for highly interactive behavior in markets where that is possible.

The examples in FIG. 1 through 5 have been described with specific modules, user interface elements, configurations, and presentations. Embodiments are not limited to systems according to these example configurations. Customer engagement acceleration may be implemented in configurations using other types of user interface elements, presentations, and configurations in a similar manner using the principles described herein.

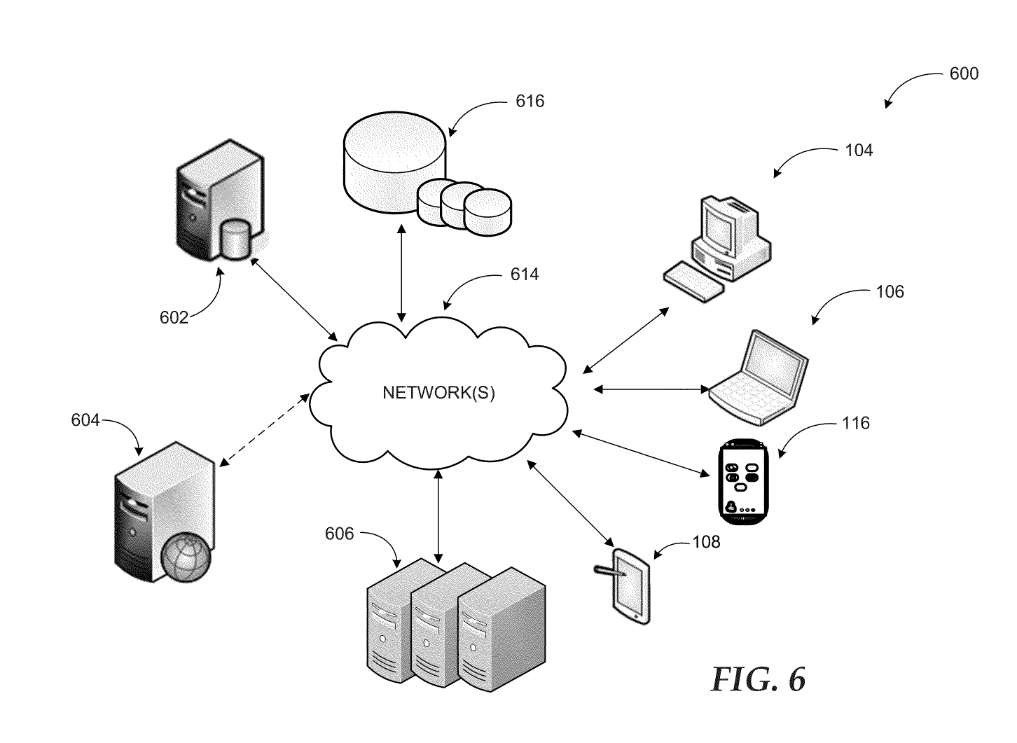

FIG. 6 is an example networked environment, where embodiments may be implemented. A system facilitating customer resource management with engagement acceleration may be implemented via software executed over one or more servers 606 such as a hosted service. The platform may communicate with client applications on individual computing devices such as the desktop computer 104, laptop computer 106, smart phone 116, and tablet 108 (‘client devices’) through network(s) 614.

Client applications executed on any of the client devices may facilitate communications with hosted customer resource management service or another form of customer engagement service executed on servers 606, or on individual server 604. Intelligent, scalable, and timely recommendations based on learned customer interaction and activity may be provided, while allowing any given person in an external facing role the autonomy of action. The customer engagement accelerator may retrieve relevant data from data store(s) 616 directly or through database server 602, and provide requested services to the user(s) through the client devices.

Network(s) 614 may comprise any topology of servers, clients, Internet service providers, and communication media. A system according to embodiments may have a static or dynamic topology. Network(s) 614 may include secure networks such as an enterprise network, an unsecure network such as a wireless open network, or the Internet. Network(s) 614 may also coordinate communication over other networks such as Public Switched Telephone Network (PSTN) or cellular networks. Furthermore, network(s) 614 may include short range wireless networks such as Bluetooth or similar ones. Network(s) 614 provide communication between the nodes described herein. By way of example, and not limitation, network(s) 614 may include wireless media such as acoustic, RF, infrared and other wireless media.

Many other configurations of computing devices, applications, data sources, and data distribution systems may be employed to implement a platform providing customer engagement acceleration. Furthermore, the networked environments discussed in FIG. 6 are for illustration purposes only. Embodiments are not limited to the example applications, modules, or processes.

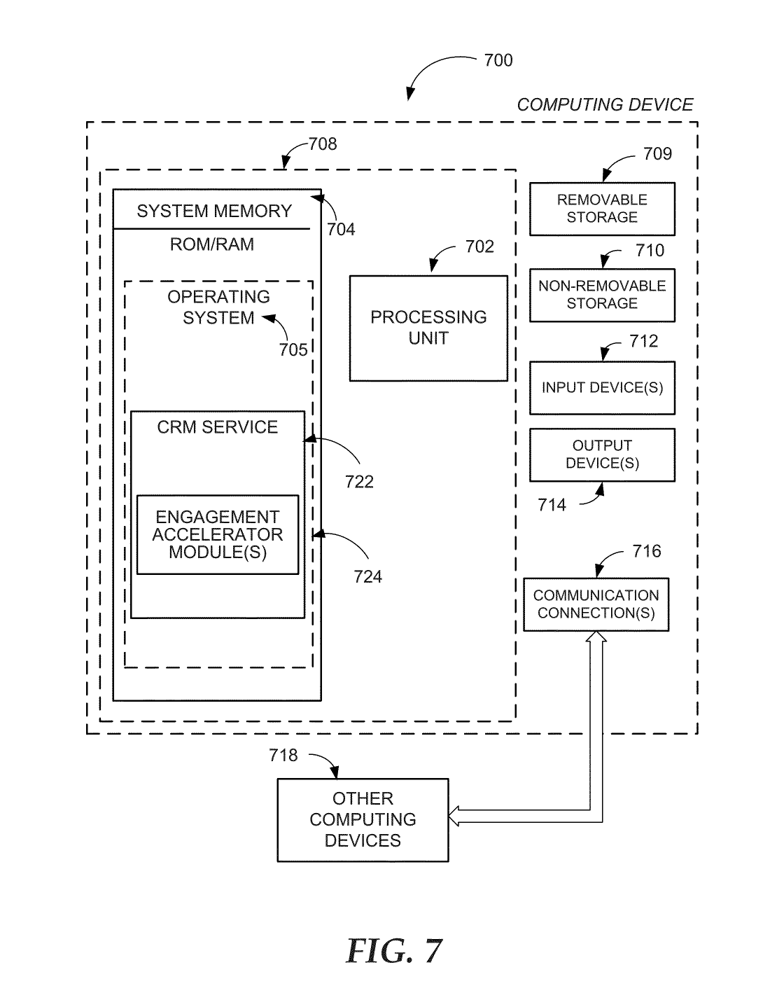

FIG. 7 and the associated discussion are intended to provide a brief, general description of a suitable computing environment in which embodiments may be implemented. With reference to FIG. 7, a block diagram of an example computing operating environment for an application according to embodiments is illustrated, such as the computing device 106. In a basic configuration, computing device may be any computing device with communication capabilities, and include at least one processing unit 712 and a system memory 704. The computing device 700 may also include a plurality of processing units that cooperate in executing programs. Depending on the exact configuration and type of computing device, a system memory 704 may be volatile (such as RAM), non-volatile (such as ROM, flash memory, etc.) or some combination of the two. The system memory 704 typically includes an operating system 705 suitable for controlling the operation of the platform, such as the WINDOWS®, WINDOWS MOBILE®, or WINDOWS PHONE® operating systems from MICROSOFT CORPORATION of Redmond, Wash. The system memory 704 may also include one or more software applications such as engagement acceleration module(s) 722.

The engagement acceleration module(s) 722 may employ a concerted series of phases based on feedback/input and interaction with a number of processes to determine prospects, guide them to offered services/products, and provide suitable actions to sales/marketing/customer service professionals. This basic configuration is illustrated in FIG. 7 by those components within a dashed line 708.

The computing device 700 may have additional features or functionality. For example, the computing device 700 may also include additional data storage devices (removable and/or non-removable) such as, for example, magnetic disks, optical disks, or tape. Such additional storage is illustrated in FIG. 7 by a removable storage 714 and a non-removable storage 716. Computer readable storage media may include volatile and nonvolatile, removable and non-removable media implemented in any method or technology for storage of information, such as computer readable instructions, data structures, program modules, or other data. The system memory 704, removable storage 714 and the non-removable storage 716 are all examples of computer readable memory device. Computer readable memory devices include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other physical medium which can be used to store the desired information and which can be accessed by the computing device 700. Any such computer readable storage media may be part of the computing device 700. The computing device 700 may also have the input device(s) 718 such as keyboard, mouse, pen, voice input device, touch input device, an optical capture device for detecting gestures, and comparable input devices. An output device(s) 720 such as a display, speakers, printer, and other types of output devices may also be included. These devices are well known in the art and need not be discussed at length here.

Some embodiments may be implemented in a computing device that includes a communication module, a memory device, and a processor, where the processor executes a method as described above or comparable ones in conjunction with instructions stored in the memory device. Other embodiments may be implemented as a computer readable memory device with instructions stored thereon for executing a method as described above or similar ones. Examples of memory devices as various implementations of hardware are discussed above.

The computing device 700 may also contain communication connections 722 that allow the device to communicate with other devices 726, such as over a wired or wireless network in a distributed computing environment, a satellite link, a cellular link, a short range network, and comparable mechanisms. Other devices 726 may include computer device(s) that execute communication applications, web servers and the comparable device 107. Communication connection(s) 722 is one example of communication media. Communication media can include therein computer readable instructions, data structures, program modules, or other data. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be collocated with each other, but each can be only with a machine that performs a portion of the program.

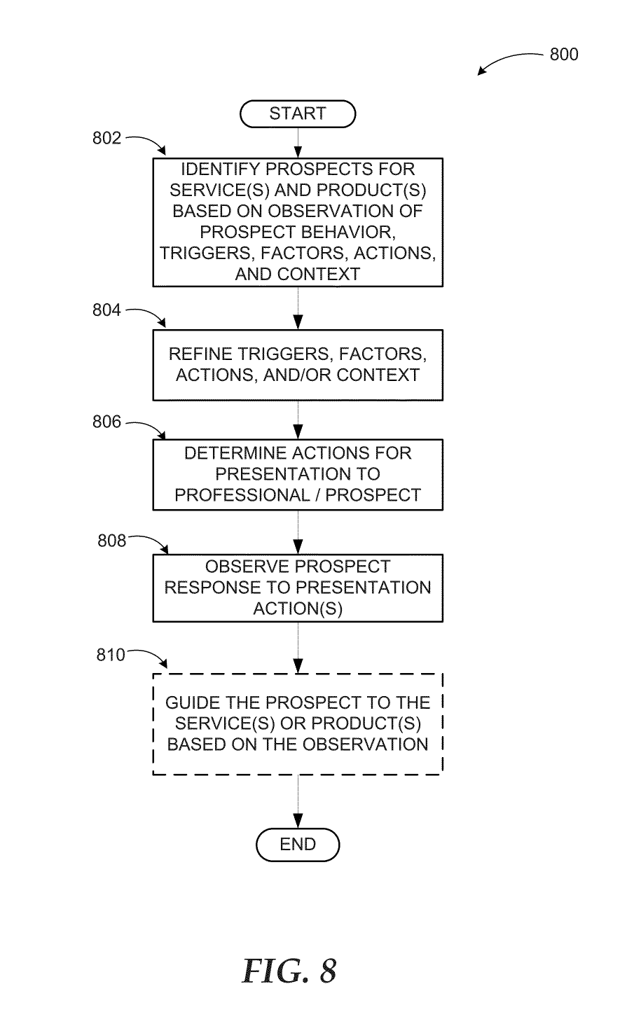

FIG. 8 illustrates a logic flow diagram for a process 800 of providing customer engagement acceleration according to embodiments. The process 800 may be implemented on a server or other computing device.

The process 800 begins with an operation 802, where one or more prospects for service(s) and/or product(s) may be identified based on observation of prospect behavior, triggers, factors, actions, and context. At operation 804, the triggers, factors, actions, and/or context may be refined as described herein. In some embodiments, a pool of prospects may also be refined.

At operation 806, a set of actions associated with the identified prospects may be determined for presentation to a professional or direct presentation to a prospect. For example, the actions may include presentation of shareable content to the prospect(s) to encourage them to consider the offered service(s) or product(s). At operation 808, a prospect response to presentation of one or more actions from the set of actions may be observed for selection/refinement of next set of actions, pool of prospects, and overall marketing strategy.

At optional operation 810, the prospect may be guided to the one or more service and/or product based on the observation, refinement, and additional analyses such as trend analysis, statistical analysis, insight inference, etc.

The operations included in the process 800 are for illustration purposes. Customer engagement acceleration may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method to be executed at least in part in a computing device for customer engagement acceleration, the method comprising:
identifying one or more prospects for one or more service and product based on observation of prospect behavior, triggers, factors, actions, and context;
refining one or more of the triggers, factors, actions, and context;
determining a set of actions associated with the identified prospects for one of presentation to a professional and direct presentation to a prospect;
observing a prospect response to presentation of one or more actions from the set of actions; and
guiding the prospect to the one or more service and product based on the observation.

2. The method of claim 1, wherein the presentation of the one or more actions from the set of actions includes presentation of content to the one or more prospects.

3. The method of claim 2, wherein the content is shareable.

4. The method of claim 2, further comprising:
one of creating, syndicating, and purchasing the content such that the prospect is encouraged to share the content with other prospects.

5. The method of claim 2, further comprising:
selecting a flow of the content to move prospects sequentially through a phased experience such that the prospects are transitioned from a potential customer to an actual customer via threads.

6. The method of claim 5, further comprising:
presenting the prospects with attributes and choices associated with the content that enable the prospects to discover their own path through the experience.

7. The method of claim 5, wherein the phased experience includes one or more of realization, internalization, and visualization.

8. The method of claim 7, wherein the phased experience further includes one or more of decision, justification, and evangelization.

9. The method of claim 1, further comprising:
refining the set of actions based on input from one or more of the prospect and the professional.

10. The method of claim 9, further comprising:
performing one or more of trending analysis, statistical analysis, and insight inference for the refinement.

11. The method of claim 1, further comprising:
generating a dynamic profile of the one or more prospects based on identified prospects and prospect responses to presented actions.

12. The method of claim 11, wherein the dynamic profile is for one of individual prospects and aggregation of prospects.

13. A computing device for management of customer engagement acceleration, the computing device comprising:
a memory;
a communication module configured to interact with a plurality of other computing devices associated with customers, professionals, and related services; and
a processor coupled to the memory and the communication module, the processor executing a customer engagement acceleration module, wherein the customer engagement acceleration module is configured to:
identify one or more prospects for one or more service and product based on observation of prospect behavior, triggers, factors, actions, and context;
refine one or more of the triggers, factors, actions, and context;
determine a set of actions associated with the identified prospects for one of presentation to a professional and direct presentation to a prospect;
observe a prospect response to presentation of one or more actions from the set of actions;
refine the set of actions based on input from one or more of the prospect and the professional; and
guide the prospect to the one or more service and product based on the observation.

14. The computing device of claim 13, wherein the customer engagement acceleration module is further configured to perform big data analysis on potential actions on and by the one or more prospects.

15. The computing device of claim 13, wherein the customer engagement acceleration module is further configured to enable human input for one or more of selection of actions, selection of prospects, and refinement of the set of actions.

16. The computing device of claim 13, wherein the customer engagement acceleration module is further configured to identify the one or more prospects based on a set of offered services and products.

17. The computing device of claim 13, wherein the professional is one of a sales professional, a marketing professional, and a customer support professional, and the prospects are one of new customer and existing customer.

18. A computer-readable memory device with instructions stored thereon for customer engagement acceleration, the instructions comprising:
identifying one or more prospects for one or more service and product based on observation of prospect behavior, triggers, factors, actions, and context;
refining one or more of the triggers, factors, actions, and context;
determining a set of actions associated with the identified prospects for one of presentation to a professional and direct presentation to a prospect, wherein the presentation of the one or more actions from the set of actions includes presentation of shareable content to the one or more prospects;
observing a prospect response to presentation of one or more actions from the set of actions; and
guiding the prospect to the one or more service and product based on the observation.

19. The computer-readable memory device of claim 18, wherein the instructions further comprise:
for each potential action, determining a trigger/context factor based on weighting for sales, marketing, and service aspects associated with the action; and
selecting an action for engaging the prospect based on the weighted trigger/context factor.

20. The computer-readable memory device of claim 19, wherein the instructions further comprise:
dynamically updating the weighting based on prospect response to the action, wherein the context is employed to inform conversations with the prospect, and the factors are one of ongoing and time bound.
